(19) United States
(12) Patent Application Publication
(10) Pub. No.: US 2005/0160890 A1
(43) Pub. Date: Jul. 28, 2005

(54) Device for cutting track-like material as well as method for producing cross sections in a track-like material

(75) Inventor: Felix Titz, Weiherhammer (DE)

Correspondence Address: MERCHANT & GOULD PC, P.O. BOX 2903, MINNEAPOLIS, MN, 55402-0903, US

(73) Assignee: BHS Corrugated Maschinen-und Anlagenbau GmbH, Weiherhammer (DE)

(21) Appl. No.: 10/981,136

(22) Filed: Nov. 3, 2004

(30) Foreign Application Priority Data
Jan. 12, 2004 (DE) 10 2004 001 758.1

(51) Int. Cl. B26D 1/00

(52) U.S. Cl. 83/13

(57) ABSTRACT

The present invention relates to a device 7 for cutting track-like material 1 as well as a method for producing transverse cuts 6 in a track-like material 1 in a continuous operating process. To increase the service life of the device 7 and to improve the cut reliability, it is proposed that the counter-tool 10 to the cutting tool 8 form, in the active position (cutting position), a blunt counter-surface 12 for the cutting tool 8, which counter-surface is in direct contact with the track-like material 1 and is not cuttable.

The present invention relates to a device for cutting track-like material according to the preamble of patent claim 1 as well as to a method for producing cross sections in a track-like material according to the preamble of patent claim 13.

In the production of manufactured items of, for example, paperboard or corrugated paperboard, the production process starts from a track-like material that is generally supplied in the form of rolls. This track-like material, in a continuous processing procedure for production of different products, is first cut longitudinally by means of a longitudinal cutter into several longitudinal tracks (panels) of defined width (first track division) and subsequently further processed. A changing of the size of the products in the continuous process takes place in that cuts for longitudinal tracks (panels) of different widths (second track division after size change) are produced by means of the longitudinal cutter. In the transition region of between the first and second track division, at least one cut running in the transverse direction is produced. The device according to the invention as well as the method according to the invention are designed to produce such a cut.

U.S. Pat. No. 5,152,205 shows a device for cutting track-like material, which device displays a rotating knife that cuts against a circulating belt consisting of elastic material. The belt is supported in the active position (cutting position) through a vertically movable cylinder with die at the side opposite to the rotating knife, but is not supported in the passive position (non-cutting position).

The cutting against soft material causes a high wear of the belt, and as a consequence, a short service life, i.e. frequent service intervals. In addition, the cut reliability is not ensured.

Known from EP-A-0 894 583 B1 is a device for cutting track-like material, wherein individual knife pieces can be folded outwards from a rotating roller and these knives in the active position cut against a roller consisting of soft material, in particular polyurethane. The soft material of the roller is subjected to a high wear, which leads to a short service life.

The task of the present invention consists in further developing the generic device and the generic method such that, first, the service life of the device is increased, and second, a high degree of cutting reliability exists.

The above task is achieved, in connection with the object of patent claim 1, through the fact that the counter-tool to the cutting tool in the active position forms a blunt counter-surface that is in direct contact with the track-like material, which counter-surface is not cuttable for the cutting tool. “Not cuttable” means that the counter-tool is not to undergo any accepted wear, as is the case in the prior art. The track-like material is thus cut with application of a non-cuttable counterbearing. Through the fact that the counterbearing is not cuttable, a frequent replacement of the latter is unnecessary. At the same time, through the device according to the invention a high degree of cutting reliability is ensured.

Appropriately, the counter-tool consists of hard material, e.g. hardened steel. Through the fact that the counter-tool can be moved essentially horizontally from the active position into a passive position (non-cutting position) and vice versa, on the one hand a reduced space requirement is made possible, while on the other hand the counter-tool in the passive position can be used to support the track-like material, since the movement of the counter-tool takes place parallel to the plane of the track-like material.

Appropriately, the counter-tool includes individual tool segments that are selectably movable, individually or in groups, in an essentially horizontal manner from the active into the passive position and vice versa. Through this means, according to the selection of the tool segments in question, any partial cuts in any length and arrangement can be carried out in the transverse direction to the track-like material.

In an advantageous manner, the counter-tool is provided with a support device, which, for example, can be designed as at least one fixed crossbeam, along which the individual tool segments are located.

According to a further embodiment of the present invention, the counter-tool is damped, in particular sprung. Through this means the knife is somewhat relieved of load in the active position.

Appropriately, the counter-tool is harder than the cutting tool. According to an alternative embodiment, the counter-tool and the cutting tool can also possess approximately equal hardness.

In a further appropriate embodiment of the present invention, a rotating cutter bar or a swinging cutter bar is provided as the cutting tool.

In order to produce transverse cuts in discrete size and arrangement, in an alternative embodiment the cutting tool displays individual cutting tool segments that can be brought from an active position into a passive position, and vice versa. In this case the counterbearing is not segmented.

In order to accomplish the task of the patent, in the method according to the invention the following process steps are proposed:
positioning of a cutting tool on a first side of the longitudinal path of the track-like material;
positioning of a counter-tool on a second side of the longitudinal path of the track-like material;
selection of at least one section of the track-like material;
transverse cutting of the track-like material in the region of the at least one selected section;
for the cutting, the cutting tool comes into direct contact with a blunt counter-surface of the counter-tool, which counter-surface is not cuttable by the cutting tool.

Here, the transverse cutting can take place over the entire width of the track-like material or over only a part of this width, i.e. without a breaking of the track-like material.

In order to produce the transverse cuts of defined length as well as position, the counter-tool appropriately includes a plurality of counter-tool segments, which are movable, individually or combined into groups, in an essentially horizontal manner from an active position into a passive position and vice versa.

Due to the horizontal movability, it is possible that the track-like material constitutes a support for the track-like material also in the passive position of the counter-tool or of the relevant counter-tool segments, as the case may be.

For the sake of clarity, identical, recurring features are labeled only once with a reference numeral.

In the following, appropriate embodiments of the present invention are explained in detail with reference to the drawings. These show:

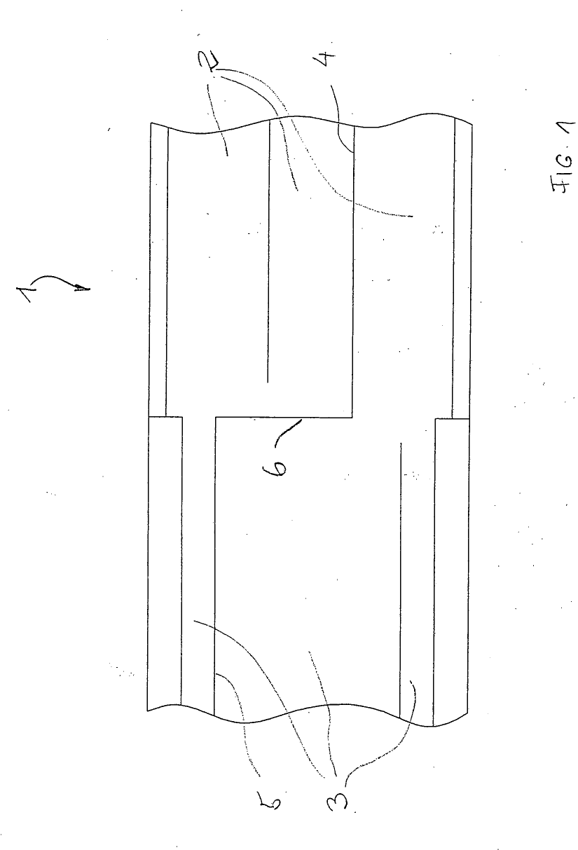

FIG. 1: a format width change between a first track division and a second track division during the processing of track-like material in a continuous operating process;

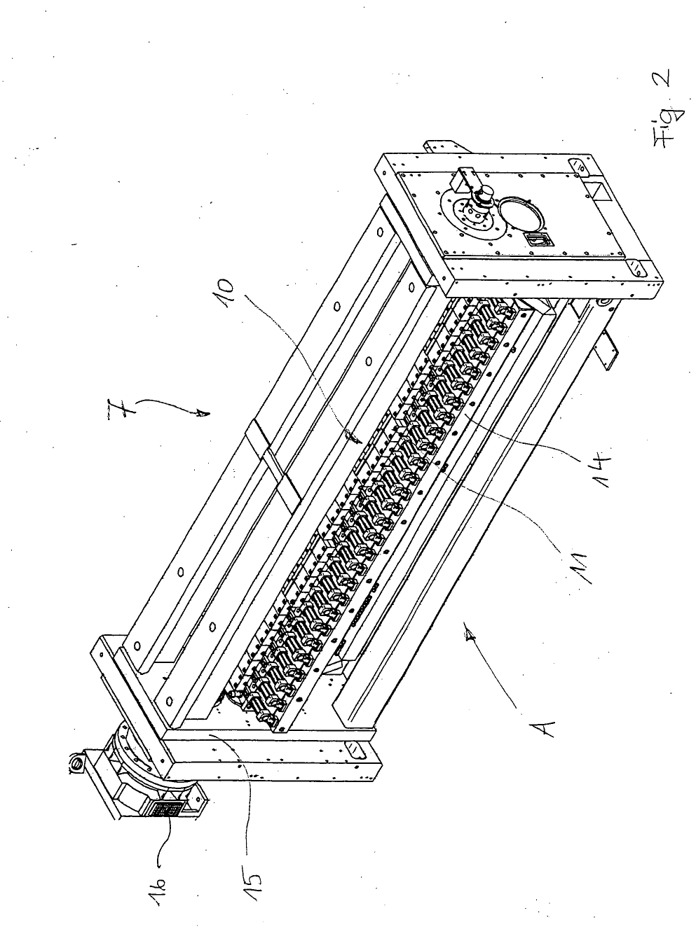

FIG. 2: an embodiment form of the device for cutting by application of individual cutting-tool segments, represented in perspective;

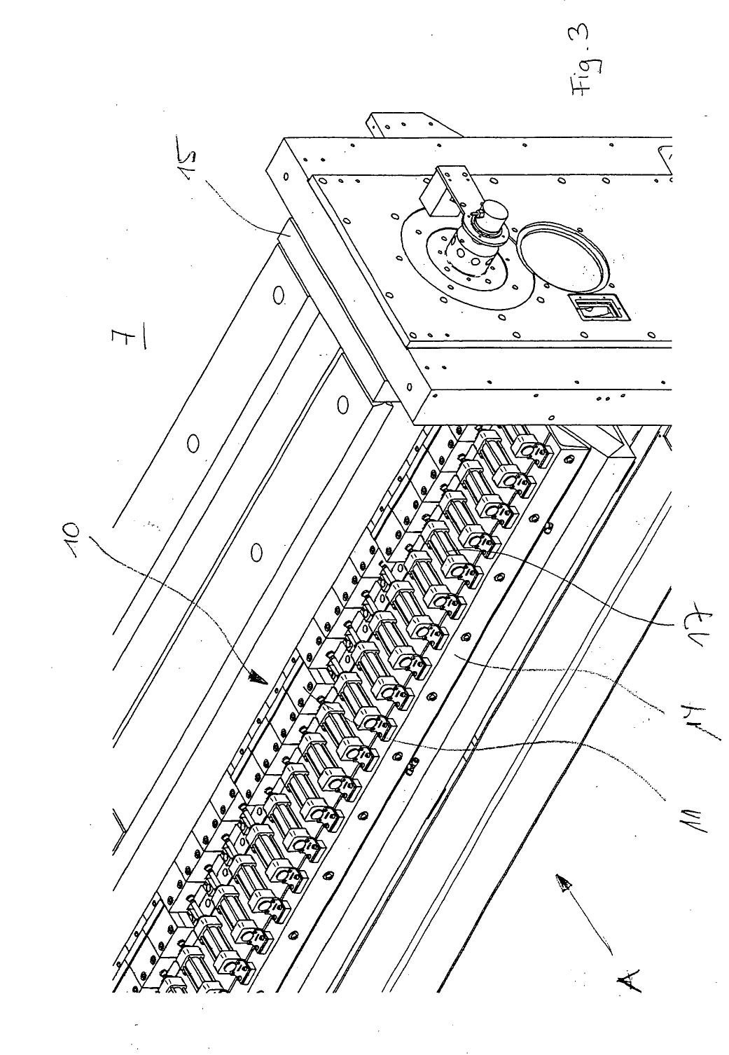

FIG. 3: a somewhat enlarged detail representation from FIG. 2 for clarification of the different positions of the cutting-tool segments;

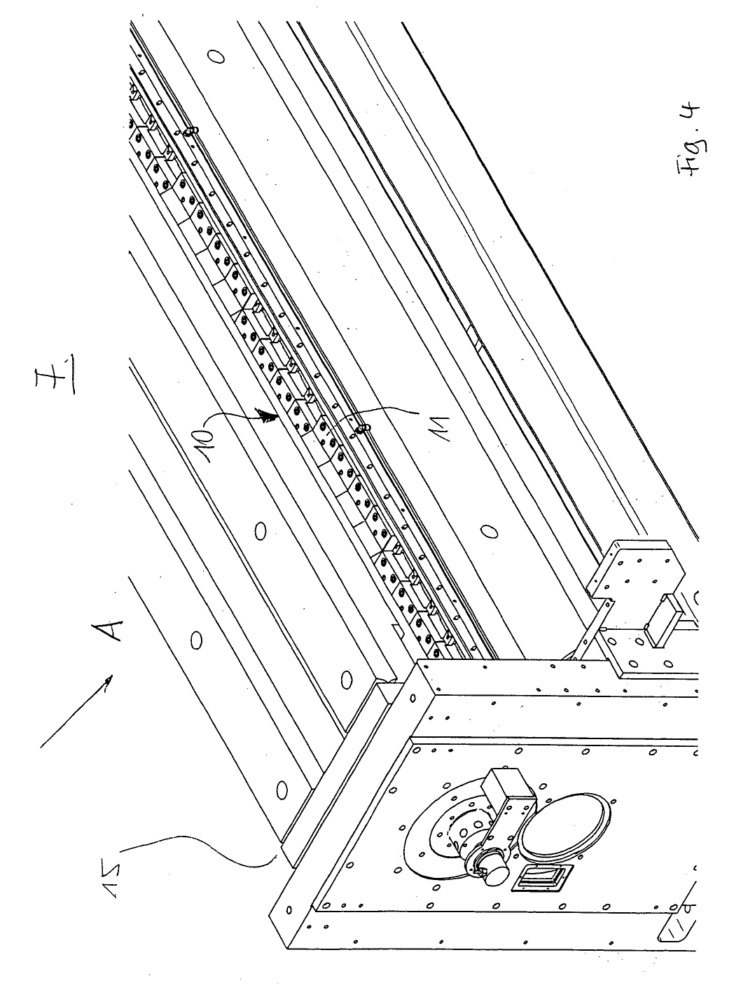

FIG. 4: a representation of the arrangement of the cutting-tool segments according to the embodiment form in FIG. 3, from a perspective point of view from the rear;

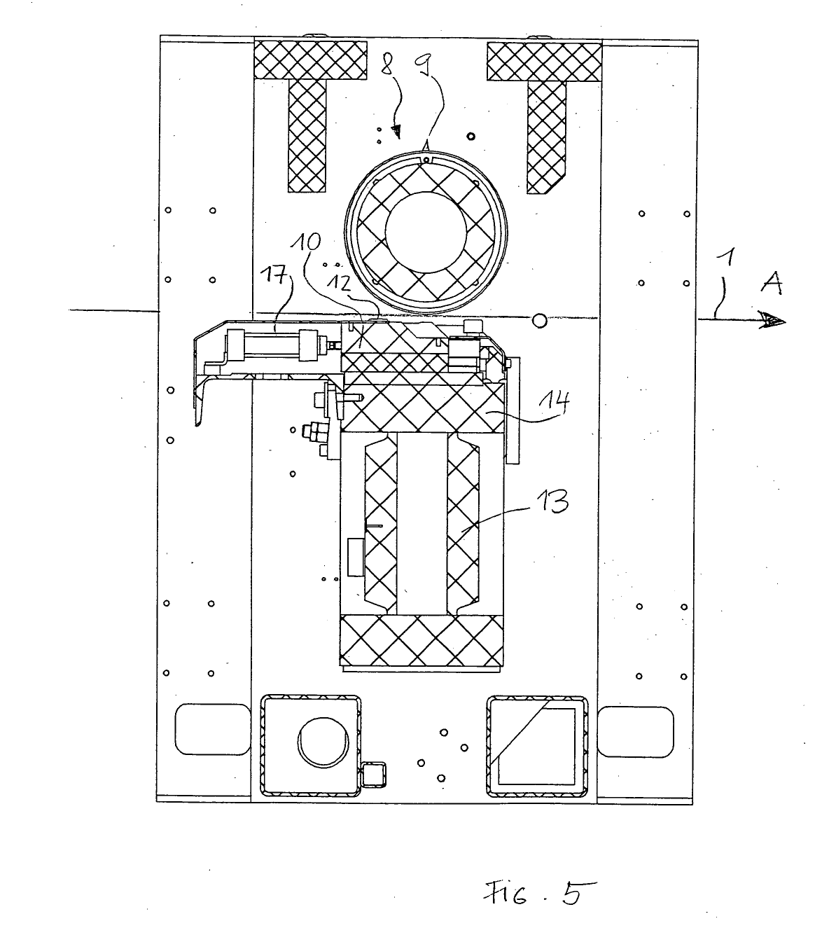

FIG. 5: a sectional representation of the device according to the inventions for cutting track-like material according to the above embodiment form.

Reference numeral 1 indicates a track-like material, as for example corrugated paperboard, that is processed in a continuous process. For the simultaneous production of differently-sized manufactured items (e.g. folded boxes made of corrugated paperboard) the track-like material 1 is divided by longitudinal cuts 4 into several tracks (“panels”). The right segment in FIG. 1 represents a first format-width region with several panels 2. This first format-width region is cut by a knife arrangement (not shown in FIG. 1).

In a change of the format widths to products of a different size, there occurs by means of the knife arrangement a format-width change from the first track division to a second track division with panels 3, which division is characterized by the cut lines 5. This format-width change likewise takes place in a continuous production process.

In order to ensure a trouble-free transition from the first format-width region to the second format-width region, transverse cuts 6 are provided in the transition region. The transverse cut 6 in FIG. 1 connects a longitudinal cut 4 of the first format-width region to a longitudinal cut 5 of the second format-width region. Two additional transverse cuts positioned in the edge region lie in the region of the offset of the edge-side cut in each case (trim).

FIG. 2 shows an appropriate embodiment of the device 7 according to the invention for producing the transverse cut 6 in FIG. 1.

The device 7 includes a frame 15, within which the track-like material 1 (not shown in FIG. 2) is continuously moved in the transport direction A. For the cutting of the track-like material 1, a cutting tool 8 is provided, in the form of a rotating cylinder provided with a knife 9 (see FIG. 5). In this embodiment, the knife 9 extends over the entire width of the track-like material 1.

The device 7 includes a counter-tool 10, which in the embodiment according to FIG. 2 displays a multiplicity of individual cutting-tool [sic] segments 11, which, individually or combined into groups, are movable in a horizontal direction from an active position into a passive position, and vice versa, through appropriate control means (not shown in the figure).

The individual counter-tool segments 1 are supported along a transversely-running crossbeam 14, which is connected to the frame 15. The cylinder provided with a knife 9, which cylinder is not shown in FIG. 2, is driven via a drive 16 provided laterally on the frame 15.

From the enlarged representation according to FIG. 3, the respective position of the counter-tool segments 11 inside the device 7 according to the invention is made clear. Thus, those counter-tool segments 11 that lie further downstream in the transport direction A are in the active position, i.e. the cutting position, while in contrast the remaining segments are in the passive position. The counter-tool segments 11 are moved via drive elements connected in each case to these segments, which elements are in the form of cylinders 17 that make possible two positions, namely an extended position and a retracted position. The drive elements are individually controlled directly via control equipment (not shown in FIG. 3).

From the representation according to FIG. 4, the backside view of the device 7 according to the invention is apparent. The counter-tool segments 11 advanced in the transport direction A are those that are in the active position.

FIG. 5 shows, in sectional view, the device according to the invention in the above-described embodiment form.

Situated directly adjacent to the cutting tool 8 is the counter-tool 10. In the gap formed between the cutting tool 8 and the counter-tool 10 runs the track-like material 1. The counter-tool 10 likewise extends over the entire widths of the track-like material 1.

By “gap” is to be understood that a convergence between the knife 9 of the cutting tool 8 and the counter-tool 10 can be realized through a knife-adjustment device on the side of the cutting tool 8 and/or through a height adjustment of the counter-tool 10. If a cut is not being made, then a gap exists between the knife 9 and the counter-tool 10. During the cutting, the knife 9 and the counter-tool 10 are in direct contact. Appropriately, a pressing force is provided here, for example at least 5000 N, prefereably 7000-13000 N, preferably 9000-11000 N.

The counter-tool 10 is borne by a support device 13, which displays at its top side as well as bottom side in each case a crossbeam 14. The crossbeam 14 appropriately possesses a height adjustment (not show in FIG. 5) by means of which the gap between the cutting tool 8 and the counter-tool 10 can be changed.

Provided at the top side of the support device 13 is a slightly elevated counter-surface 12 for the knife 9 of the cutting tool 8. The counter-tool 10 or rather counter-surface 12 is not itself cuttable by the knife 9 of the cutting tool 8. With respect to the material hardness, the counter-tool 10 appropriately meets the following approximate condition: hardness_{counter-tool}≧hardness_{knife}. For example, the counter-tool 10 can consist of hardened steel.

The respective knife 9 of the cutting tool 8 is appropriately lubricated, e.g. with oil, by means of a lubrication arrangement (not shown in FIG. 5). Alternatively or in addition to this, a readjustment device can be provided for the respective knife 9 of the cutting tool 8, in order that the knives may be readjusted multiple times before they are replaced.

In order to bring the device for cutting from an active position (cutting position) into a passive position and vice versa, the counter-tool 10 (in the present embodiment example, each counter-tool segment 11 as part of the counter-tool 10) is movable in a horizontal direction, in other words approximately parallel to the plane of the track-like material 1. For this purpose, the counter-tool 10 is movable on a carriage (not shown) by means of an associated cylinder 17, which can be pneumatically movable via a control cylinder (likewise not shown). Through this means, the counter-surface 12 of the counter-tool 10 can be brought into the active or passive position, and this according to whether a cut of the track-like material I is desired or not.

According to the invention, the cut is ensured through direct placement of the knife 9 against the counter-surface 12 of the counter-tool 10 consisting of hard material.

In the embodiment form represented in FIGS. 2-4 of the device according to the invention, the counter-tool 10 is divided into a multiplicity of counter-tool segments 11, which in each case are controlled individually and/or in groups and are movable as needed into the respective active or passive position. Through this means, any cut positions and/or cut lengths can be realized over the width of the track-like material 1.

The horizontal displacement, i.e. occurring parallel to the plane of the track-like material 1, of the counter-tool 10 or counter-tool segments 11 ensures the advantage that the counter-tool 10 or counter-tool segments 11 in the passive position serve(s) as a support for the track-like material 1. Incidentally, this structure requires only a shallow structural depth.

According to a further embodiment form that is not represented in the figures, instead of a segmentation of the counter-tool 10, a segmentation of the cutting tool 8, for example through individual and individually-controllable knives, can also be provided.

With the present invention, a considerable lengthening of the service life of the generic device for cutting track-like material is achieved. In addition to this, an increased cutting reliability is also ensured. Finally, the device according to the invention necessitates a comparatively small space requirement for the structure. All in all, the invention consequently represents a quite exceptional enrichment of the related prior art.

### Reference Numeral List

1 track-like material
2 panels in the first format-width region
3 panels in the second format-width region
4 longitudinal cut (first format-width region)
5 longitudinal cut (second format-width region)
6 transverse cut
7 device for cutting
8 cutting tool
9 knife
10 counter-tool
11 counter-tool segments
12 counter-surface
13 support device
14 crossbeam
15 frame
16 drive
17 cylinder

1. Device for cutting track-like material (1), which is continuously led through the device along a feed path, having a single- or multiple-part cutting tool (8) that is provided over the width of the feed path, a counter-tool (10) to the cutting tool (8), wherein the track-like material (1) runs through with its top side and bottom side between the cutting tool (8) and the counter-tool (10), wherein the counter-tool (10) for the cutting tool (8) forms, in the active position, a blunt counter-surface (12) for the cutting tool (8), which counter-surface is in direct contact with the track-like material (1) and is not cuttable by the cutting tool (8).

2. Device according to claim 1, wherein the counter-tool (10) consists of hard material.

3. Device according to claim 1, wherein the counter-tool (10) is movable in an essentially horizontal manner from the active position into a passive position (non-cutting position) and vice versa.

4. Device according to claim 1, wherein the counter-tool (10) displays individual tool segments (11) that are movable, individually and/or in groups, in an essentially horizontal manner from the active position into the passive position and vice versa.

5. Device according to claim 1, wherein a support device (13) is provided for the counter-tool (10).

6. Device according to claim 5, wherein a crossbeam (14), in particular a fixed crossbeam, is provided as the support device (13).

7. Device according to claim 1, wherein the counter-tool (10) is damped, in particular sprung.

8. Device according to claim 1, wherein the counter-tool (10) is harder than the cutting tool (8).

9. Device according to claim 1, wherein the counter-tool (10) and the cutting tool (8) possess an approximately equal hardness.

10. Device according to claim 1, wherein at least the counter-surface (12) of the counter-tool (10) consists of hardened steel.

11. Device according to claim 1, wherein a rotating cutter bar or swinging cutter bar is provided as the cutting tool (8).

12. Device according to claim 1, wherein the cutting tool (8) displays individual cutting-tool segments that can be brought from an active position into a passive position and vice versa.

13. Method for producing transverse cuts in a track-like material that is continuously or discontinuously led through a cutting device, having the following process steps:
positioning of a cutting tool (8) on a first side of the longitudinal path of the track-like material (1),
positioning of a counter-tool (10) on a second side of the longitudinal path of the track-like material (1),
selection of at least one section of the track-like material (1), and
transverse cutting of the track-like material (1) in the region of the at least one selected section,
wherein for the cutting, the cutting tool (8) comes into direct contact with a blunt counter-surface of the counter-tool (10), which counter-surface is not cuttable by the cutting tool (8).

14. Method according to claim 13, wherein the track-like material (1) is cut without breakage of the track-like material (1).

15. Method according to claim 13, wherein the counter-tool (10) includes a multiplicity of counter-tool segments (11) that, individually or combined into groups, can be moved in an essentially horizontal manner from an active position into a passive position and vice versa.

16. Method according to claim 13, wherein the track-like material (1) rests on the counter-tool (10) or counter-tool segment (11), as the case may be, also in the passive position of the counter-tool (10) or the counter-tool segments (11), as the case may be.
